(19) United States
(12) Patent Application Publication
(10) Pub. No.: US 2008/0184066 A1
(43) Pub. Date: Jul. 31, 2008

(54) REDUNDANT SYSTEM

(75) Inventors: Shih-Jen Chuang, Hsin-Chu (TW); Chang-Cheng Yap, Hsin-Chu (TW); Bo-Yuan Shih, Hsin-Chu (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: RDC SEMICONDUCTOR CO., LTD., Hsin-Chu (TW)

(21) Appl. No.: 11/751,091

(22) Filed: May 21, 2007

(30) Foreign Application Priority Data
Jan. 26, 2007 (TW) 096103038

(51) Int. Cl. G06F 11/00

(52) U.S. Cl. 714/6

(57) ABSTRACT

A redundant system comprising at least two hosts is provided. The redundant system randomly selects one active host under normal operating conditions, and sets the other hosts on stand-by. The active host controls the other hosts and peripheral devices connecting thereto through buses.

This application claims the benefit of priority based on Taiwan Patent Application No. 096103038 filed on Jan. 26, 2007.

### CROSS-REFERENCES TO RELATED APPLICATIONS

Not applicable.

### BACKGROUND OF THE INVENTION

1. Field of the Invention

The present invention relates to a redundant system. More particularly, the invention relates to a redundant system comprising at least two hosts, of which the redundant system randomly selects one host in a normal operation.

2. Descriptions of the Related Art

Every operational system has a risk of hardware failure. When the hardware failure occurs, commands and operations in the system cannot run smoothly and thus, impede proper functioning of the system. Therefore, a parallel-linked redundant system is provided for reducing the risk of hardware failure. When the operational system fails, the redundant system continues to execute the commands and operations.

Conventional redundant systems comprise a plurality of hosts simultaneously running all the commands and operations under normal conditions. A decision mechanism is responsible for maintaining the activity of the hosts. For example, when the functioning of the hosts are not identical, the decision mechanism decides which result is correct and renders control power to the host with the correct result for running the commands and operations. The failed hosts are then determined to be malfunctioning and cease to have control power.

The aforementioned redundant system generally comprises a hardware fault-tolerant system and software fault-tolerant system. The decision mechanism is configured to connect all the hosts to form the complex fault-tolerant systems. The redundant system is typically applied in fields that require high security and confidentiality, such as satellites, missile lunch systems, submarines, aircrafts, and space shuttles. Because of the expensive costs, these redundant systems cannot be used in common everyday appliances as a controlling instrument. Another kind of conventional redundant system comprises two hosts running the same commands and operations. For convenient explanation purposes, one of the two hosts is denoted as the primary host, while the other is denoted as the redundant host. Normally, the primary host and the redundant host simultaneously run the same commands and operations. Like the previously mentioned redundant system, a decision mechanism is responsible for the activity between the two hosts. The difference is that the decision mechanism in this system first renders the control power to the primary host. When the primary host fails, the decision mechanism then renders the control power over to the redundant host.

Because the aforementioned redundant systems need at least two hosts running simultaneously, the hardware cost is still high. When one host is removed from the redundant system, the entire system can no longer function. Thus, since conventional decision mechanisms and redundant systems have been designed to function as a whole system with its parts highly dependent of each other, it has been difficult to add or remove hardware from the redundant system without making the entire system useless.

Despite the complexity of designing a redundant system, it is still important to design a redundant system for use in general manufacturing facilities or control instruments with the ability of adding or removing hardware because of its useful application in situations such as hardware failures.

### SUMMARY OF THE INVENTION

The primary objective of this invention is to provide a redundant system comprising at least two hosts and to randomly set one host active under a normal condition. The rest of the hosts of the redundant system are on stand-by and are referred to as “rest hosts” throughout this document. The active host can control the rest hosts and peripheral hardware thereof via bus.

To achieve the aforementioned objective, each host of the redundant system comprises a system-failure-logic module, a memory module, and a control module. The system-failure-logic module is connected to the other system-failure-logic modules of the rest hosts to ensure that the redundant system can set one active after start-up. The system-failure-logic module is also configured to determine the operation status of the host thereof and transfer the control power of the host according to the operation status. The memory module is configured to store the operation data of the host. The control module is configured to control the operation of the host.

The present invention is advantageous because it only needs one host to run at a time. The system can also randomly add or remove hosts when necessary.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is the first embodiment of the present invention;

FIG. 2 is a connection diagram of two system-failure-logic modules of the first embodiment;

FIG. 3 is a diagram of the memory module of the first embodiment;

FIG. 4 is the second embodiment of the present invention; and

FIG. 5 is the third embodiment of the present invention.

### DESCRIPTION OF THE PREFERRED EMBODIMENT

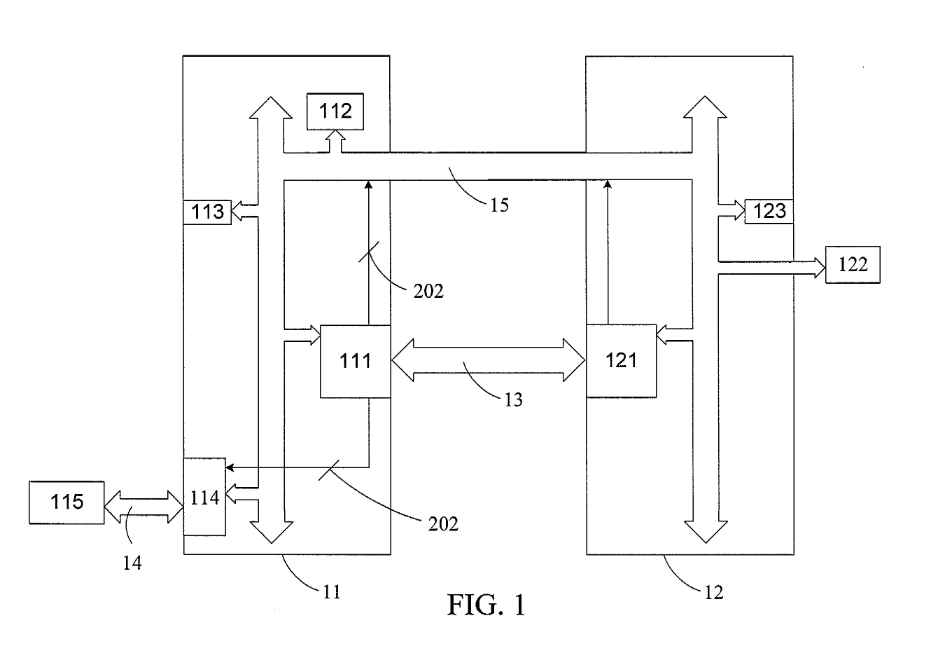

FIG. 1 shows the first embodiment of the present invention, of which the redundant system comprises two hosts that communicate with each other. When one host is abnormal, the other host can replace the abnormal host to ensure that the system is running smoothly. In the present invention, the host is comprised of electric hardware that aid in running commands and communicating with other hosts. Thus, the host can be a computer system, a computer, a circuitry board comprising a plurality of chips, or a system-on-chip module.

In the first embodiment, though the redundant system comprises a host 11 and a host 12, the system only runs one host at a time, while the other host remains on stand-by. The host 11 comprises a system-failure-logic module 111, a memory, such as a memory module 112, and a control module, such as a CPU 113. The host 12 comprises a system-failure-logic module 121, a memory module 122, and a CPU 123. In the depicted embodiment (shown in FIG. 1), the host runs commands under the central processing mode. As expected, the host can run commands under other modes as well. For example, a host with a direct memory access (DMA) mode can also run commands under the DMA mode.

The system-failure-logic module 111 and the system-failure-logic module 121 are connected to each other via a bus 13. The bus 13 is configured to provide a connection between the hardware. The bus 13 can be, for example, a global bus, a standard bus, or another kind of bus defined for mutual-connection and data-transmission between the hardware. Generally, the global bus can be in a PCI, ISA, UART, parallel port format, or any global-compatible-bus format. The standard bus can be in a PCI, ISA format, or any standard-compatible-bus format. The memory modules 112 and 122 are configured to store the operation data of the host, and can be an internal memory, such as a RAM, another suitable memory module for storing data, or an external memory. In the present embodiment, the memory module 112 is an internal memory, while the memory module 122 is an external memory. The CPU 113 and 123 are configured to control the operation of the hosts respectively. For example, in the present embodiment, the CPU 113 connects to a local bus 14 via a peripheral interface 114, and to another peripheral hardware 115 via the local bus 14. Meanwhile, either CPU 113 or CPU 123, can control another host on stand-by while it is in operation via a standard bus 15.

The system-failure-logic module 111 and the system-failure-logic 121 are configured to ensure that the redundant system can set the host 11 or host 12 in a normal condition after start-up. The system-failure-logic module 111 and 121 are also configured to determine the operation status of the host 11 and 12 respectively and transfer the control power of the host according to the operation status.

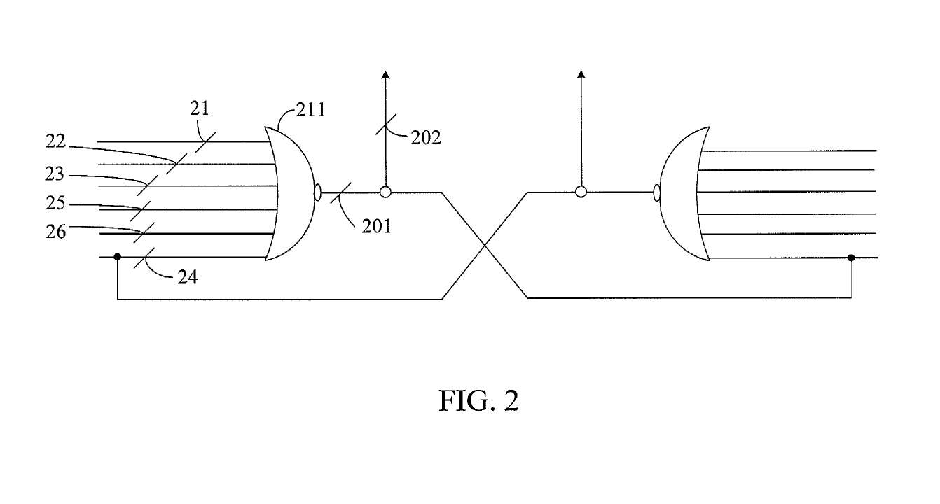

For example, the system-failure-logic module 111 receives a plurality of fail sources for determining the operation status of the host 11. The fail sources are roughly divided into two groups: internal fail sources and external fail sources. FIG. 2 shows the connection diagram of the system-failure-logic module 111 and 121. The internal fail sources each comprise an invalid op code 21, watchdog 22, software control signal 23, and system-B-active-in signal 24, while the external fail sources each comprise a reset signal 25 and manual switch signal 26. Note that the system-B-active-in signal 24 indicates that another system is active. In the present embodiment, the system-failure-logic module 121 comprises the same fail sources and thus, unnecessary details are omitted here.

FIG. 2 also shows a connection diagram of the latch-up logic. The system-failure-logic module 111 or 121 is realized in an NOR gate. Still using the system-failure-logic module 111 as an example, the NOR gate 211 has six input terminals that are connected to the aforementioned six fail sources respectively. When any one of the six fail sources shows logic HIGH, the output signal 201 of the system-failure-logic module 111 shows logic LOW, indicating that the system has failed, i.e. the host 11 cannot run normally. The control power is then transferred to the host 12. The system-failure-logic module 111 also outputs a tri-state enable signal 202 to the connection part of the standard bus 15 and the host 11. The connection between the standard bus 15 and the host 11 is thus enabled as a tri-state, which means the host 11 can only receive signals transmitted from the standard bus 15 but cannot transmit signals via the standard bus 15. In FIG. 1, the tri-state enable signal 202 is also outputted to the peripheral interface 114, enabling a tri-state connection between the local bus 14 and the host 11.

According to the latch-up logic, the system-failure-logic module 121 keeps running under normal operation, and the host 12 can control the host 11 via the standard bus 15 under a central processing mode or a DMA mode. The host 12 can also control the peripheral hardware and internal hardware connected to the host 11, such as the memory module 112. The system-failure-logic module can also be realized by an NAND gate, in which the latch-up logic formed by the connection of the two system-failure-logic modules is consistent with the above descriptions.

Because the fail sources comprise a reset signal 25 and manual switch signal 26, the system can be reset or switched to manual operation when the host 11 changes from normal operation to stand-by. The host 11 can then resume running normally. Since the latch-up logic only enables one system-failure-logic module to output the logic HIGH when the system starts up, it can randomly set either the host 11 or host 12 as the active host.

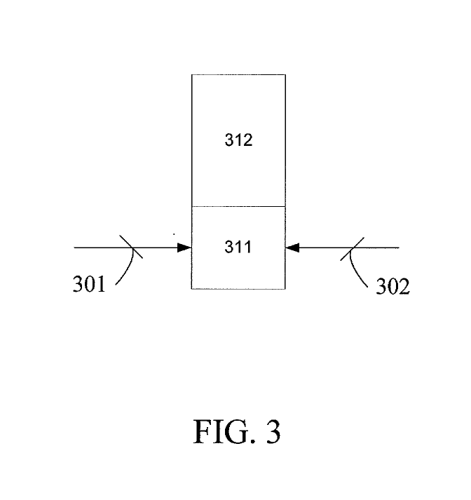

FIG. 3 further details the memory module 112, which comprises an arbitration module 311 and a single-port memory module 312. The single-port module 312 can only receive one accessing signal at a time. When the host 11 is on stand-by, the single-port memory module 312 can receive the internal accessing signal 301 from the host 11, or the external accessing signal 302 from the host 12, for reading stored data in the single-port memory module 312. The arbitration module 311 arbitrates these accessing signals to determine the accessing priority of the accessing signals 301 and 302. The memory module 122 can also comprise a single-port memory module and an arbitration module. The memory module 112 can comprise a two-port memory module where both hosts, 11 and 12, can access the memory module 112 simultaneously.

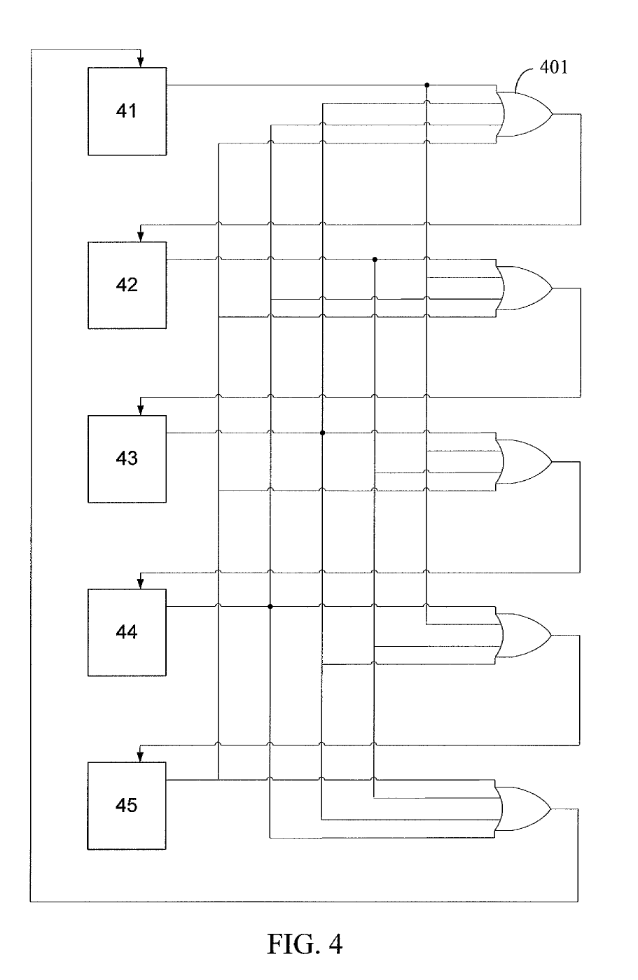

The second embodiment of the present invention is a redundant system comprising five hosts as shown in FIG. 4. FIG. 4 shows the logic connection between the system-failure-logic modules of the five hosts. The system-failure-logic modules 41, 42, 43, 44, and 45 are mutually connected via five OR gates. Every OR gate comprises four input terminals. Using OR gate 401 as an example, the four input terminals of the OR gate 401 respectively receive four output signals from the four system-failure-logic modules, except from the system-failure-logic module 42. The output signal of the OR gate 401 is then transmitted to the system-failure-logic module 42. By the same principle, every system-failure-logic module only receives one external fail source, which means that the second embodiment can detect the two-host connection between each of the five hosts.

By similar principle of connection, when there are N hosts mutually connected, and N is larger than three, there will be N OR gates required for mutual connection. Every OR gate comprises N−1 input terminals, and the connection method is substantially the same as illustrated in FIG. 4.

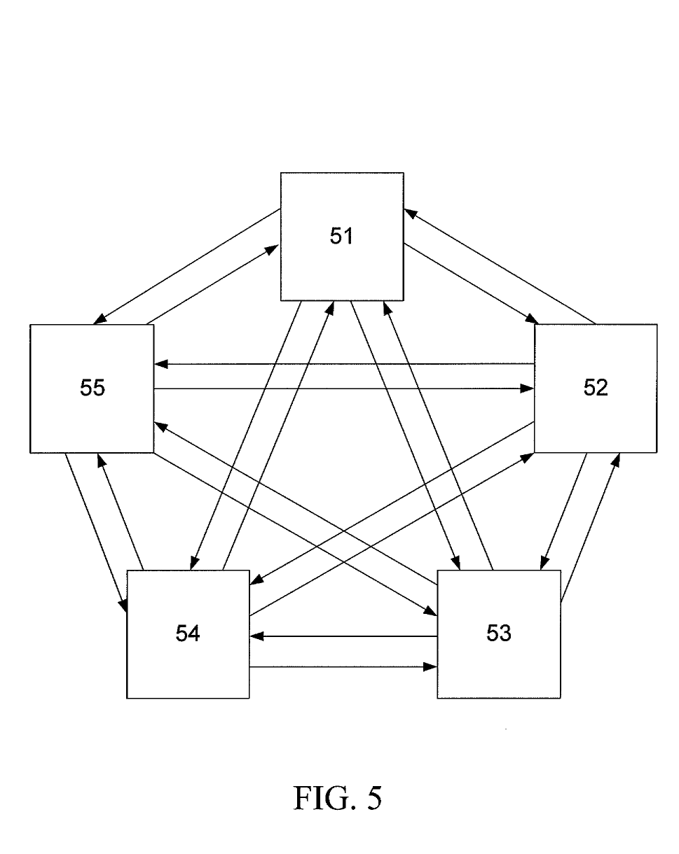

The third embodiment of the present invention is a redundant system comprising five hosts as shown in FIG. 5. FIG. 5 shows the logic connection between the system-failure-logic modules 51, 52, 53, 54, and 55 of the five hosts. There is no further logic gate needed in the embodiment, and every system-failure-logic module directly connects to the rest of the system-failure-logic modules respectively. All hosts are mutually connected via common buses; therefore, every host can receive all fail sources of the redundant system. This is another method in which the system can detect the two-host connection in each of the five hosts. Similarly, when there are N hosts, the hosts can be mutually connected via the output terminals of the system-failure-logic module of each host.

The host and the system-failure-logic module shown in the second and the third embodiments are as illustrated in the first embodiment, and unnecessary details are omitted here.

With the aforementioned disclosures, the present invention needs to only run only one host of a redundant system at a time, and is thus, able to randomly add or remove hosts from the redundant system when necessary.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A redundant system, comprising:
at least two hosts, the hosts are mutually connected via at least one bus, each host comprising:
a system-failure-logic module being connected to the system-failure-logic modules of other hosts, for ensuring the redundant system being able to set one host in normal condition after start-up, and for determining operation status of the host and determining to transfer the control power of the host according to the operation status;
a memory module being configured to storing operation data of the host; and
a control module being configured to controlling operation of the host;
wherein the host in normal condition controls the rest hosts and peripheral hardware connected to the rest hosts via the bus.

2. The redundant system as claimed in claim 1, wherein the system-failure-logic module comprises a plurality of fail sources for determining the operation status of the host according to the fail sources.

3. The redundant system as claimed in claim 2, wherein the fail sources comprise internal fail sources and external fail sources.

4. The redundant system as claimed in claim 2, wherein the fail sources comprise invalid op code, watchdog, reset signal, software control signal, manual switch signal, and system-B-active-in signal.

5. The redundant system as claimed in claim 1, wherein the system-failure-logic modules of different hosts are mutually connected by latch-up logic.

6. The redundant system as claimed in claim 1, wherein the at least one bus is a global bus or a standard bus.

7. The redundant system as claimed in claim 1, wherein the host is one of a system-on-chip module, a computer, and a computer system.

8. The redundant system as claimed in claim 1, wherein the at least one bus is a Tri-state bus.

9. The redundant system as claimed in claim 1, wherein the memory module comprises a two-port memory module.

10. The redundant system as claimed in claim 1, wherein the memory module comprises a single-port memory module and a arbitration module, and the arbitration module is configured to arbitrating accessing priority of accessing the single-port memory module.

11. The redundant system as claimed in claim 1, wherein the hosts are connected to the peripheral hardware via local buses respectively.

12. The redundant system as claimed in claim 1, wherein the control module of the host in normal condition controls the rest hosts and peripheral hardware connected to the rest hosts via the bus by at least one of central processing mode and direct memory access mode.
